(19) United States
(12) Patent Application Publication
(10) Pub. No.: US 2011/0012752 A1
(43) Pub. Date: Jan. 20, 2011

(54) Wireless control for valve operating machine

(75) Inventor: Scott J. Ferrar, Hoffman Estates, IL (US)

Correspondence Address: ROBERT L. MARSH, 54 DANADA DRIVE, P.O. BOX 4468, WHEATON, IL, 60189-4468, US

(73) Assignee: ILLINOIS TOOL WORKS INC., Glenview, IL (US)

(21) Appl. No.: 12/821,325

(22) Filed: Jun. 23, 2010

Related U.S. Application Data
(60) Provisional application No. 61/225,288, filed on Jul. 14, 2009.

(51) Int. Cl. H04Q 9/00

(52) U.S. Cl. 340/870.07

(57) ABSTRACT

A controller for a valve turning machine includes a handheld unit having a keypad and a first transmitter for transmitting instructions to the machine. The machine itself has a receiver for receiving instructions, and one or more detectors for detecting the status of functions of the machine. A second transmitter on the machine transmits information from the detectors as feedback to the handheld unit.

The applicant claims priority from his provisional application filed on Jul. 14, 2009 and assigned Ser. No. 61/225,288. The present invention relates to a wireless controller for a valve operating machine that receives feedback from the machine, enabling the operator to use the wireless controller to instruct the machine in response to the feedback.

### BACKGROUND OF THE INVENTION

To provide water throughout a municipality, the water system includes underground piping having relatively large diameters and correspondingly large valves. The valves are positioned below ground and are reachable by an elongate key that extends through a shaft to the valve stem. The key is in turn rotated by a hydraulic motor that applies torque to the key.

In general, the valves of a typical water system are infrequently operated and have often been buried below ground for many years. Rust, corrosion and debris can interfere with the moveable parts of a valve, and it is sometimes necessary to stop an exercise while the valve is partially open and reverse the direction of rotation for a few turns to clear the moving parts of obstructions. The operation, or exercise of such valves must therefore be carefully undertaken so as not to damage the valve by applying excessive torque or attempting to rotate the valve beyond the limit of its movement. To avoid damaging the valve, it is therefore desirable to maintain a record for each time the valve is exercised and to consult the record of the prior operation before initiating the exercise of a valve. The valve is therefore exercised in light of its history as shown from the records.

U.S. Pat. No. 5,381,996 issued Jan. 17, 1995 discloses a valve operating machine that includes a detector for detecting the amount of torque applied to a valve to exercise it. A hydraulic motor on the valve operating machine is controlled by a computer which receives input from the torque-detection device so as not to apply excessive torque to the valve stem. The valve operator further includes a counter for counting the revolutions of the valve stem and terminating the exercise after the valve has rotated through the predetermined number of rotations required to change its orientation from an open condition to a closed condition, or from a closed condition to an open condition.

To prevent damage to the valves of a municipal water system each valve must be carefully monitored as it is being exercised. Any irregularity in the operation of the valve is recorded and becomes part of the history available to operators exercising the valve in the future. It is therefore important that the events that occur with each operation of the valve be recorded in the memory of a computer for transferring to permanent records in a central office. It is desirable therefore, that all the technicians who operate the valve turning machine of a municipal water system carry with them a handheld computer having an memory for retaining the history of the valves to be exercised. When a valve is exercised, the computer is capable of recording any new information relevant to the valve, including its final condition, open or closed, the number of turns required to change its condition, and any irregularities in its operation. The new information is then downloaded when the technician returns to the central office and becomes part of the history of the valve. In order to provide a complete history of the operation of a valve, it is desirable that the computer be handheld and be capable of receiving information from the detectors in the valve operating machine, such as the counter that records the number of rotations of the valve stem and the torque detector. Existing computer operated valve turning machines have a handheld control unit that is connected by a detachable cable to the valve operating machine. Wires in the cable convey information detected by detectors in the valve turning machine to the computer in the handheld unit and convey instructions to the machine from the technician holding the handheld controller. The handheld computer is disconnected from the machine after a valve has been exercised and the information in the computer is transferred through another wire to the master computer in the central office.

Where the handheld controller for a valve operating machine is connected to the machine by a cable, the technician is required to be positioned relatively near the machine, which may result in risk to the technician. Furthermore, the cable itself may become damaged as a result of the operation of the machine thereby causing an adverse effect on its operation. It would be desirable, therefore, to provide a wireless handheld control unit that includes a computer and a memory that can be updated from input from the machine while the machine is being operated.

### SUMMARY OF THE INVENTION

Briefly, the present invention is embodied in a wireless controller for operating a valve turning machine of the type having a reversible hydraulic motor. The machine rotates the stem of a valve through a predetermined number of turns to change the valve from an open condition to a closed condition or from a closed condition to an open condition. The controller includes detectors on the valve turning machine for providing output indicative of the performance of various functions of the machine such as the number of rotations through which the stem has turned and the torque being applied to the stem of the valve. The device further has a wireless first transmitter and keyboard on the handheld unit for transmitting instructions that a technician inputs into the keypad to a remote wireless receiver.

A wireless first receiver on the valve turning machine receives the transmission from the first transmitter, and an electronic logic on the valve turning machine operates the hydraulic valves causing the machine to perform as instructed. A second wireless transmitter on the valve turning machine transmits information received from the various detectors on the machine and a second wireless receiver on the handheld unit receives the transmissions from the second transmitter on the valve turning machine. The information received is then recorded in the memory of the computer. A technician using the controller of the present invention can therefore operate a machine in response to feedback from the detectors on the machine, and feedback from the machine is recorded in the memory of the handheld controller.

### BRIEF DESCRIPTION OF THE DRAWINGS

A better and more complete understanding of the present invention can be had from a reading of the following detailed description taken in conjunction with the drawings wherein:

FIG. 1 is a view of a valve turning machine having a handheld controller in accordance with the invention being used to turn a valve of a municipal water system; and

FIG. 2 is an block diagram of the elements of a wireless controller for the valve turning machine shown in FIG. 1.

### DETAILED DESCRIPTION OF PREFERRED EMBODIMENT

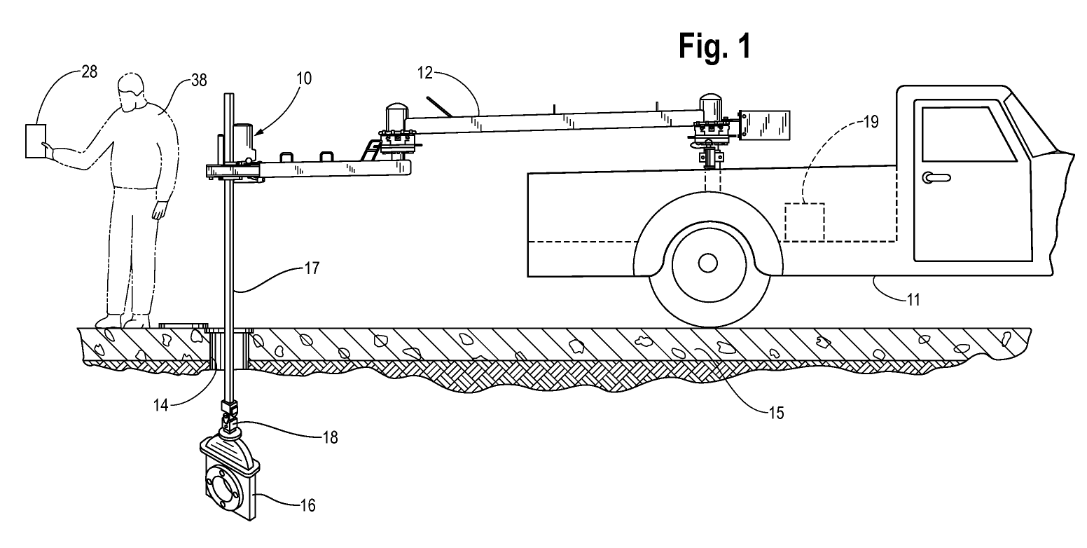

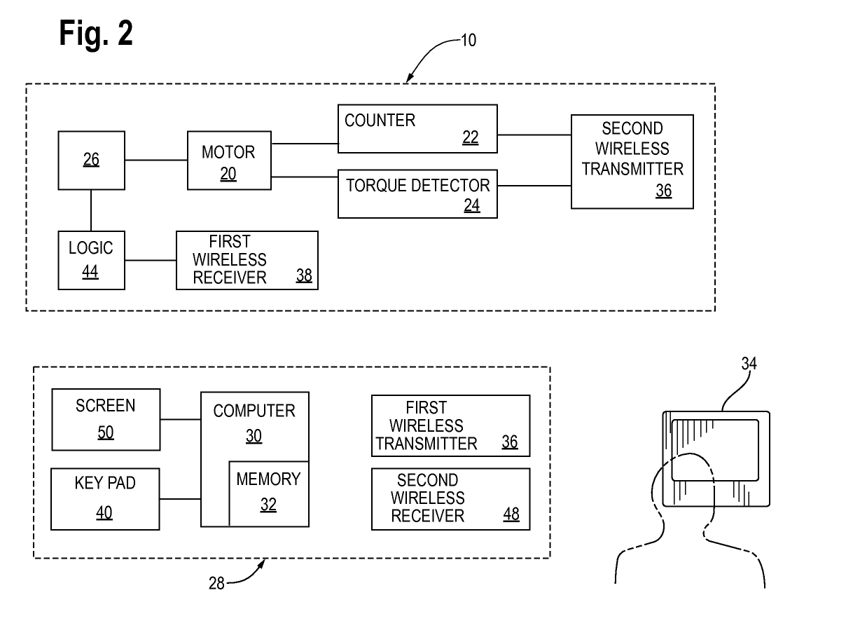

Referring to FIGS. 1 and 2, a valve turning machine 10 mounted on a vehicle 11 and is supported by an arm 12 over an aperture 14 in a layer of pavement 15. Below the pavement 15 is a valve 16 of a municipal water system. An elongate key 17 connects the valve turning machine 10 to the stem 18 of the valve 16. The machine 10 rotates the key 17 which in turn rotates the stem 18 to open or close the valve 16.

The vehicle 11 has a hydraulic compressor 19 which provides pressurized hydraulic fluid to a reversible hydraulic motor 20 that rotates the key 17 and the stem 18. The machine 10 has a counter 22 thereon that counts the number of rotations of the motor 20 and therefore the rotations of the valve stem 18. The machine also has a torque detector 24 that measures the torque being applied by the machine 10 to the stem 18. The machine further has a plurality of valves, only one of which 26 is depicted but is representative of all the hydraulic valves needed to operate the machine 10. The device further includes a handheld control unit 28 that includes a computer 30 having a memory 32. Before leaving the central office to exercise one or more valves 16 of a water system, a technician 38 will download into the memory 32 of the computer 30 the operating history and the specifications of the valve 16 or valves to be operated. The specification of the valve includes the number of turns needed to fully open or fully close the valve, the direction of rotation required to open and close the valve, and the maximum torque that can be applied to rotate the valve stem. The history will include whether the valve is currently open or closed, and any problems encountered in exercising the valve 16.

In accordance with the present invention, the handheld control unit 28 also includes a first wireless transmitter 36 which transmits instructions that a technician 38 inserts into a keypad 40 on the handheld unit 28. The machine 10 also has a wireless first receiver 42 for receiving the transmissions from the transmitter 36. Electronic instructions from the first receiver 42 are converted by a logic 44 on the machine into electronic instructions to the valves 26 of the machine. The device further includes a second wireless transmitter 46 on the machine 10 that transmits output information from the counter 22 and the torque detector 24 to a second wireless receiver 48 on the handheld control unit 28. The output from the counter 22 and torque detector 24 are thereafter stored in the memory 32 of the handheld controller 28, and are used by the computer 30 to insure that the torque applied to the valve stem 18 does not exceed the limitations of the valve 16 or that the number of rotations of the valve stem 18 do not exceed the limits of the valve 16. The information received from the machine 10 by the receiver 48 may be displayed on a screen 50 on the handheld control unit 28 so as to be available to the technician 38 and aid the technician 38 in preparing the instructions he inserts in the keypad 40 of the control unit 28.

After the valve 16 has been exercised by the machine 10, the memory 32 of the computer 30 will have been updated information received during the exercising of the valve 16. The updated information in the memory 32 will then be downloaded into the memory of the central office computer 34 so as to provide an updated history of the valve 16 available to the technician 38 the next time the valve 16 is to be exercised.

Preferably, the first and second transmitters and receivers are configured to operate in parallel without causing interference to each other. Such parallel transmission technology is currently available and one such technology is marketed under the trademark Bluetooth®.

While the present invention has been described with respect to a single embodiment, it will be appreciated that many modifications and variations may be made without departing from the spirit and scope of the invention. It is therefore the intent of the appended claims to cover all such modifications and variations that fall within the spirit and scope of the invention.

What is claimed:

1. A wireless controller for operating a valve turning machine wherein said valve turning machine includes a reversible hydraulic motor to rotate a stem of a valve through a predetermined number of turns to change said valve from an open condition to a closed condition, said controller comprising
a handheld control unit,
a first wireless transmitter on said handheld unit for transmitting operating instructions to said valve turning machine,
a first wireless receiver on said valve turning machine for receiving said instructions from said first wireless transmitter, and implementing said instruction,
control means on said valve turning machine for controlling said valve turning machine in response to instructions received by said first wireless receiver,
a detector on said valve turning machine providing an output indicative of a function of said valve turning machine,
a second wireless transmitter on said valve turning machine for transmitting said output to a receiver,
a second wireless receiver on said handheld control unit for receiving a transmission from said second wireless transmitter wherein a technician can control said valve turning machine in response to feedback from said detector.

2. The wireless controller of claim 1 wherein
said detector is a counter for counting the number of rotations of said valve stem.

3. The wireless controller of claim 1 wherein
said detector measures torque applied by said machine to said valve stem.

4. The wireless controller of claim 1 wherein
said first and second transmitters and said first and second receivers work in parallel so as not to interfere with each other.

5. The wireless controller of claim 4 wherein said parallel transmissions are marketed under the trademark Bluetooth®.

6. The wireless controller of claim 1 wherein feedback from said valve turning machine is stored in said memory of said handheld control unit and downloaded into a computer in a central office as part of a history for said valve.
